(19) United States
(12) Patent Application Publication
(10) Pub. No.: US 2026/0021984 A1
(43) Pub. Date: Jan. 22, 2026

(54) MEDIUM CONVEYING APPARATUS

(71) Applicant: PFU LIMITED, Kahoku-shi (JP)

(72) Inventor: Hirotoshi Kakuda, Kahoku-shi (JP)

(21) Appl. No.: 19/265,799

(22) Filed: Jul. 10, 2025

(30) Foreign Application Priority Data
Jul. 19, 2024 (JP) 2024-116149

(51) Int. Cl. B65H 3/66; B65H 3/06; F16H 37/04; F16H 37/12; H04N 1/00

(52) U.S. Cl. CPC B65H 3/66; B65H 3/0661; H04N 1/00628; B65H 2301/4232; B65H 2401/20; B65H 2403/46; B65H 2403/47; B65H 2403/732; B65H 2555/25; B65H 2801/39; F16H 37/041; F16H 37/12

(57) ABSTRACT

A medium conveying apparatus includes a feed roller to feed a medium, a guide to restrict contact between the medium and the feed roller, a moving mechanism to move the guide, a driving source, and a drive transmission assembly to transmit a driving force for moving the guide from the driving source to the moving mechanism. The drive transmission assembly applies a load to the moving mechanism, and the load restricts transmission of force from the guide to the driving source.

### CROSS-REFERENCE TO RELATED APPLICATIONS

This patent application is based on and claims priority pursuant to 35 U.S.C. § 119(a) to Japanese Patent Application No. 2024-116149, filed on Jul. 19, 2024, in the Japan Patent Office, the entire disclosure of which is hereby incorporated by reference herein.

### BACKGROUND

The present disclosure relates to a medium conveying apparatus.

Medium conveying apparatuses, such as a scanner or a printer, perform a process such as an imaging process or an image forming process on a medium while feeding the medium by a feed roller. Such a medium conveying apparatus may include a guide to restrict contact between the feed roller and the medium before the feed roller feeds the medium.

There is a sheet feeding apparatus including a set guide that swings between a standby position and a sheet feed position. When the set guide is at the standby position, a printed medium is separated from a set roller. When the set guide is at the sheet feed position, the set roller is allowed to contact the printed medium.

### SUMMARY

The medium conveying apparatus according to one aspect of the present disclosure includes a feed roller to feed a medium, a guide to restrict contact between the medium and the feed roller, a moving mechanism to move the guide, a driving source, and a drive transmission assembly to transmit a driving force for moving the guide from the driving source to the moving mechanism. The drive transmission assembly applies a load to the moving mechanism, and the load restricts transmission of force from the guide to the driving source.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a medium conveying apparatus according to an embodiment;

FIG. 2 is a diagram illustrating a conveying path inside the medium conveying apparatus illustrated in FIG. 1;

FIGS. 3A and 3B are schematic diagrams illustrating a set guide and other components of the medium conveying apparatus illustrated in FIG. 1;

FIG. 4 is a schematic perspective view of a driving mechanism of the medium conveying apparatus illustrated in FIG. 1;

FIG. 5 is a schematic perspective view of the driving mechanism of the medium conveying apparatus illustrated in FIG. 1;

FIG. 6 is a block diagram illustrating a schematic configuration of the medium conveying apparatus illustrated in FIG. 1;

FIG. 7 is a block diagram illustrating schematic configurations of a memory and a processing circuit of the medium conveying apparatus illustrated in FIG. 1;

FIG. 8 is a flowchart of example operations of a medium conveying process performed by the medium conveying apparatus illustrated in FIG. 1;

FIG. 9 is a schematic perspective view of a driving mechanism of a medium conveying apparatus according to another embodiment;

FIGS. 10A and 10B are schematic views illustrating a driving mechanism of a medium conveying apparatus according to still another embodiment;

FIG. 11 is a schematic perspective view of a driving mechanism of a medium conveying apparatus according to still another embodiment;

FIG. 12 is a schematic perspective view of a driving mechanism of a medium conveying apparatus according to still another embodiment;

FIG. 13 is a schematic diagram illustrating a medium conveying apparatus according to still another embodiment; and

FIG. 14 is a block diagram illustrating a schematic configuration of another processing circuit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected, and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A medium conveying apparatus according to embodiments of the present disclosure will be described below with reference to the drawings. The technical scope of the present disclosure is not limited to the embodiments described below and covers equivalents of elements described below.

Medium conveying apparatuses according to embodiments of the present disclosure will be described below with reference to the drawings. The technical scope of the present disclosure is not limited to the embodiments described below and covers equivalents of elements described below.

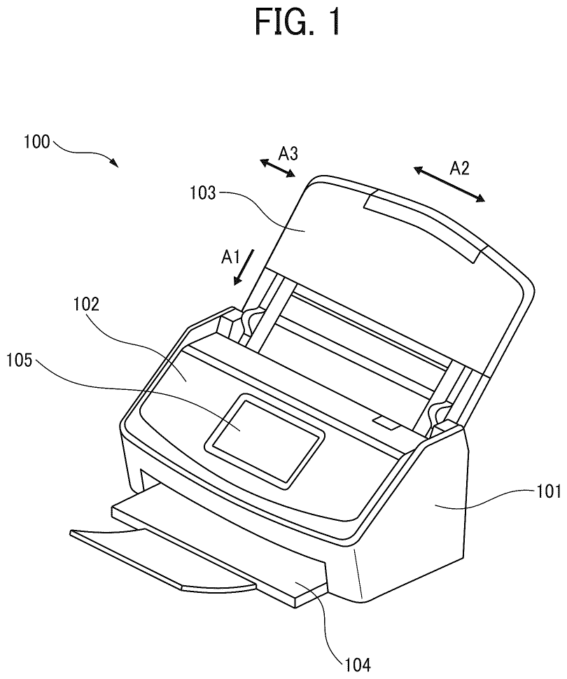

FIG. 1 is a perspective view of a medium conveying apparatus 100 as an image scanner.

The medium conveying apparatus 100 conveys, images, and ejects a medium that is a document. Examples of the medium include paper, thick paper, a card, a booklet, and a passport. The medium conveying apparatus 100 may be a facsimile machine, a copier, or a multifunction peripheral (MFP).

In FIG. 1, arrow A1 indicates the direction in which a medium is conveyed (also “medium conveying direction A1”), arrow A2 indicates the width direction perpendicular to the medium conveying direction A1, and arrow A3 indicates the height direction perpendicular to a medium conveying path. In the following, upstream is upstream in the medium conveying direction A1, and downstream is downstream in the medium conveying direction A1. The width direction A2 is an example of a direction intersecting the medium conveying direction A1.

The medium conveying apparatus 100 includes a lower housing 101, an upper housing 102, a media tray 103, an ejection tray 104, and a display and operation device 105.

The upper housing 102 is located to cover the upper side of the medium conveying apparatus 100 and is hinged to the lower housing 101 such that the upper housing 102 is openable and closable to, for example, remove a jammed medium or clean the inside of the medium conveying apparatus 100.

The media tray 103 is hinged to the lower housing 101 and is rotatable. When the medium conveying apparatus 100 is not used, the media tray 103 is positioned to cover the lower housing 101 and the upper housing 102 and functions as an exterior cover. When the medium conveying apparatus 100 is used, the media tray 103 is positioned at such a position that media to be fed and conveyed can be placed thereon. The ejection tray 104 is engaged with the lower housing 101, and the ejected media are stacked thereon. The ejection tray 104 may be engaged with the upper housing 102 with a hinge or the like.

The display and operation device 105 includes a display and an interface circuit that outputs image data to the display, and displays the image data on the display. Examples of the display include a liquid crystal display and an organic electro-luminescence (EL) display. The display and operation device 105 further includes a touch-screen input device and an interface circuit that receives signals from the input device. The display and operation device 105 receives an input operation performed by a user and outputs an operation signal corresponding to the input operation performed by the user. Alternatively, a display device and an operation device may be separate.

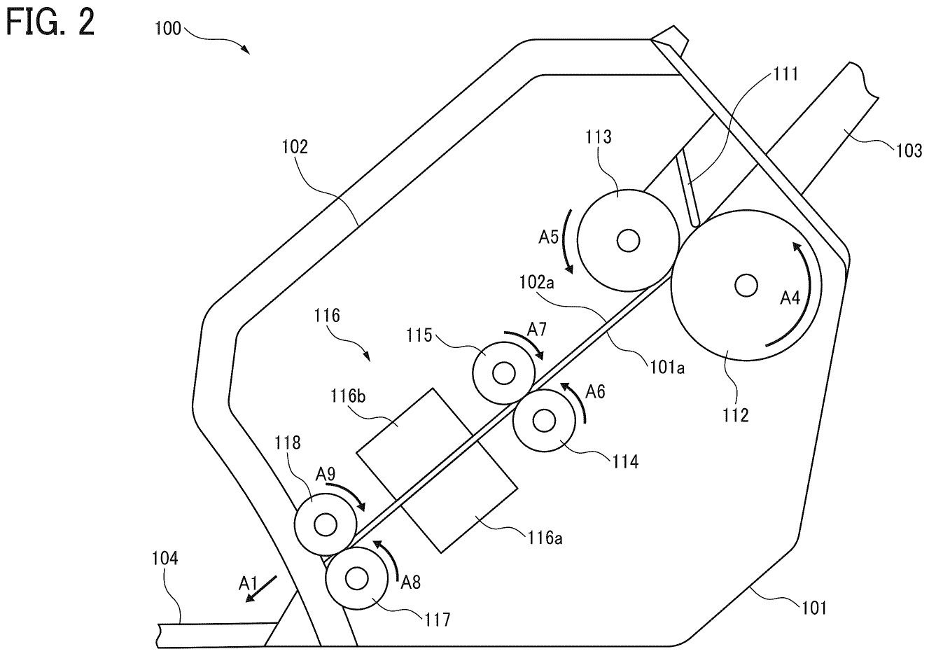

FIG. 2 is a diagram illustrating a conveying path inside the medium conveying apparatus 100.

The medium conveying apparatus 100 includes a media sensor 111, a feed roller 112, a separation roller 113, a first conveyance roller 114, a second conveyance roller 115, an imaging device 116, a first ejection roller 117, and a second ejection roller 118 along the conveying path.

The number of each of the feed roller 112, the separation roller 113, the first conveyance roller 114, the second conveyance roller 115, the first ejection roller 117, and/or the second ejection roller 118 is not limited to one but may be two or more. When the feed roller 112, the separation roller 113, the first conveyance roller 114, the second conveyance roller 115, the first ejection roller 117, and/or the second ejection roller 118 are formed of multiple rollers, the multiple rollers are located at intervals in the width direction A2.

The upper surface of the lower housing 101 forms a lower guide 101a for the medium conveying path, and the lower surface of the upper housing 102 forms an upper guide 102a for the medium conveying path. As illustrated in FIG. 2, the medium conveying path is a so-called straight path, and the vertical relative positions of the front side and the back side of a medium do not change between when the medium is fed from the media tray 103 and when the medium is ejected onto the ejection tray 104.

The media sensor 111 is located upstream from the feed roller 112 and the separation roller 113. The media sensor 111 includes a contact sensor and detects whether a medium is placed on the media tray 103. The media sensor 111 generates a media signal having a value that changes depending on whether a medium is placed on the media tray 103 and outputs the generated media signal. The media sensor 111 is not limited to a contact sensor but may be any sensor, such as an optical sensor that can detect the presence of a medium.

The feed roller 112 is in the lower housing 101, separates the media placed on the media tray 103 one by one from the bottom, and sequentially feeds the media. The separation roller 113 is a so-called brake roller or retard roller, located in the upper housing 102, and faces the feed roller 112. The separation roller 113 separates a medium from the media placed on the media tray 103. The separation roller 113 is rotatable in the direction indicated by arrow A5 opposite to the rotation direction for conveying a medium (may be referred to as a medium feeding direction in the following description). Alternatively, the separation roller 113 can be kept stationary. Instead of the separation roller 113, a separation pad may be used.

The first conveyance roller 114 and the second conveyance roller 115 are located downstream from the feed roller 112 and the separation roller 113 in the medium conveying direction A1 and face each other. The first conveyance roller 114 and the second conveyance roller 115 convey the medium fed by the feed roller 112 and the separation roller 113 to the imaging device 116.

The imaging device 116 images the medium conveyed by the first conveyance roller 114. The imaging device 116 includes a first imaging device 116a and a second imaging device 116b facing each other across the medium conveying path.

The first imaging device 116a includes an imaging sensor that is a unity-magnification contact image sensor (CIS). The CIS includes complementary metal oxide semiconductor (CMOS) imaging elements aligned linearly in the main scanning direction. The first imaging device 116a further includes a lens that forms an image on the imaging elements and an analog-to-digital (A/D) converter. The A/D converter amplifies the electrical signals output from the imaging elements and performs analog-to-digital (A/D) conversion.

The first imaging device 116a images the front side of the medium being conveyed, generates input images sequentially, and outputs the input images.

Similarly, the second imaging device 116b includes an imaging sensor that is a unity-magnification CIS including CMOS imaging elements aligned linearly in the main scanning direction. The second imaging device 116b further includes a lens that forms an image on the imaging elements and an A/D converter. The A/D converter amplifies the electrical signals output from the imaging elements and performs A/D conversion. The second imaging device 116b images the back side of the medium being conveyed, generates input images sequentially, and outputs the input images.

The medium conveying apparatus 100 may include only one of the first imaging device 116a and the second imaging device 116b to read one side of the medium. The imaging sensor may be a line sensor that employs a unity-magnification CIS including charge-coupled device (CCD) imaging elements. Alternatively, the imaging sensor may be a reduction-optical line sensor including CMOS or CCD imaging elements.

The first ejection roller 117 and the second ejection roller 118 are located downstream from the imaging device 116 in the medium conveying direction A1 and face each other. The first ejection roller 117 and the second ejection roller 118 eject the medium that is conveyed by the first conveyance roller 114 and the second conveyance roller 115 and is processed (imaged) by the imaging device 116 onto the ejection tray 104.

The media placed on the media tray 103 are conveyed between the lower guide 101a and the upper guide 102a in the medium conveying direction A1 as the feed roller 112 rotates in the direction indicated by arrow A4 in FIG. 2, which is the medium feeding direction. The separation roller 113 rotates in the direction indicated by arrow A5 opposite to the medium feeding direction or is kept stationary when a medium is fed. When two or more media are placed on the media tray 103, the medium in contact with the feed roller 112 is separated from the rest of the media placed on the media tray 103 due to the action of the feed roller 112 and the separation roller 113. This operation restricts the conveyance of a medium other than the separated medium (prevention of multi-feed).

The medium is fed between the first conveyance roller 114 and the second conveyance roller 115 while being guided by the lower guide 101a and the upper guide 102a. The medium is fed between the first imaging device 116a and the second imaging device 116b as the first conveyance roller 114 and the second conveyance roller 115 rotate in the directions indicated by arrows A6 and A7, respectively. The medium read by the imaging device 116 is ejected onto the ejection tray 104 as the first ejection roller 117 and the second ejection roller 118 rotate in the directions indicated by arrows A8 and A9, respectively.

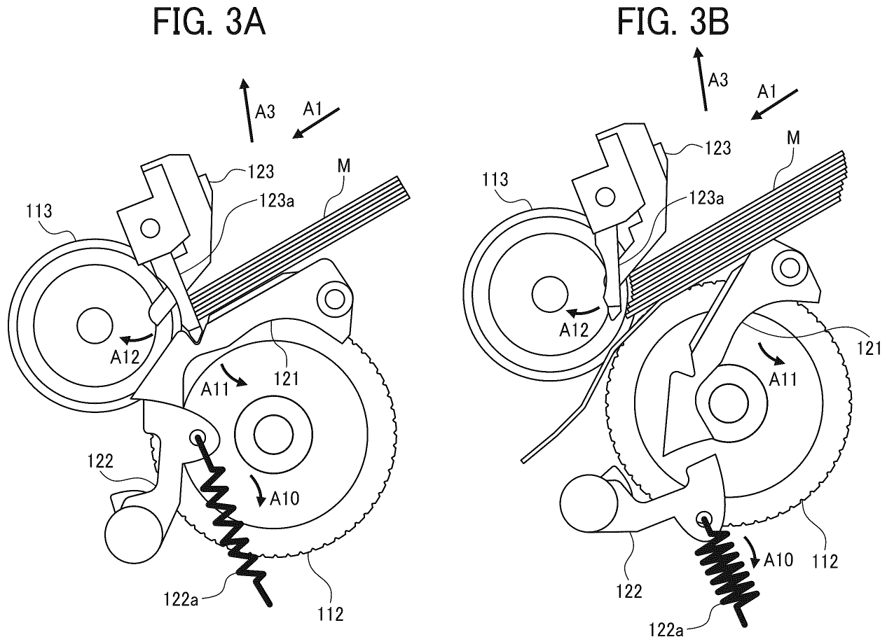

FIGS. 3A and 3B are schematic diagrams illustrating a set guide 121, a cam 122, and an arm 123. FIG. 3A is a schematic diagram of the set guide 121, the cam 122, and the arm 123 before a medium is fed as viewed from a lateral side. FIG. 3B is a schematic diagram of the set guide 121, the cam 122, and the arm 123 while a medium is fed as viewed from a lateral side.

As illustrated in FIGS. 3A and 3B, the medium conveying apparatus 100 further includes the set guide 121, the cam 122, and the arm 123.

The set guide 121 is an example of a guide to set a bundle of media M placed on the media tray 103. As illustrated in FIG. 3A, the set guide 121 is rotatably (swingably) supported by the lower housing 101. Before a medium is fed, the set guide 121 is positioned facing the feed roller 112 and the separation roller 113 in the medium conveying direction A1. When the medium M is not fed, the set guide 121 supports the lower side of the medium M placed on the media tray 103 and restricts contact between the medium M placed on the media tray 103 and the feed roller 112. In the following description, the position at which the set guide 121 restricts contact between the medium M placed on the media tray 103 and the feed roller 112 as illustrated in FIG. 3A may be referred to as a restrictive position. The restrictive position is an example of a first position.

The cam 122 is an example of a moving mechanism to move the set guide 121. The cam 122 is located below the set guide 121. The cam 122 is rotatable (swingable) by a first motor (described later). The cam 122 is supported by the lower housing 101 to be rotated by the driving force from the first motor. When a medium is not fed, the cam 122 contacts the downstream end of the set guide 121 to hold the set guide 121 at the restrictive position.

The cam 122 is provided with an elastic member 122a. The elastic member 122a is a spring, such as a tension coil spring or a torsion coil spring. One end of the elastic member 122a is attached to a frame fixed to the lower housing 101, and the other end of the elastic member 122a is attached to the cam 122. The elastic member 122a applies a downward force to the cam 122.

The arm 123 is a guide to press down the top medium of the bundle of media M on the media tray 103 or restrict the floating of the medium. The arm 123 is pressed downward toward the set guide 121 by, for example, a spring or a rubber member. The arm 123 includes a swingable flap 123a. The flap 123a is a stopper to prevent the medium M from entering the nip between the feed roller 112 and the separation roller 113 before the medium is fed. The flap 123a is located at a position facing the set guide 121 in the medium conveying direction A1. The flap 123a is an example of a restricting portion. The flap 123a is engaged with the set guide 121 positioned at the restrictive position and restricts contact between the leading end of the medium placed on the media tray 103 and the separation roller 113 before the medium is fed.

If the leading end of the medium contacts the separation roller 113 before the medium is fed, the medium is lifted by the separation roller 113 rotating in the direction opposite to the medium feeding direction, causing the medium to be jammed. With the flap 123a, the medium conveying apparatus 100 can prevent such a situation.

As illustrated in FIG. 3B, when the medium M is fed, the cam 122 swings (rotates) downward in the direction indicated by arrow A10 by the driving force from the first motor and separates from the downstream end of the set guide 121. When the downstream end of the set guide 121 separates from the cam 122 and is no longer held by the cam 122, the set guide 121 swings in the direction indicated by arrow All to a position below a media conveying plane and separates from the lower side of the medium M on the media tray 103. Accordingly, the medium placed on the media tray 103 is allowed to contact the feed roller 112. In the following description, the position illustrated in FIG. 3B at which the set guide 121 is separate from the lower side of the medium M on the media tray 103 and allows the contact between the medium M on the media tray 103 and the feed roller 112 may be referred to as a non-restrictive position. The non-restrictive position is an example of a second position. As described above, the set guide 121 is positioned at the restrictive position and the non-restrictive position, and the cam 122 moves the set guide 121 between the restrictive position and the non-restrictive position.

As described above, the elastic member 122a applies the downward force to the cam 122. Accordingly, the elastic member 122a applies a load to the cam 122 in a direction in which the set guide 121 moves from the restrictive position to the non-restrictive position.

When the set guide 121 is positioned at the non-restrictive position, the set guide 121 is released from the engagement with the flap 123a. Accordingly, the flap 123a is pushed by the leading end of the medium M on the media tray 103 and swings downstream (in the direction indicated by arrow A12), and the medium M is allowed to enter the nip between the feed roller 112 and the separation roller 113. As described above, when the set guide 121 is positioned at the non-restrictive position, the flap 123a allows the medium M to enter the nip between the feed roller 112 and the separation roller 113.

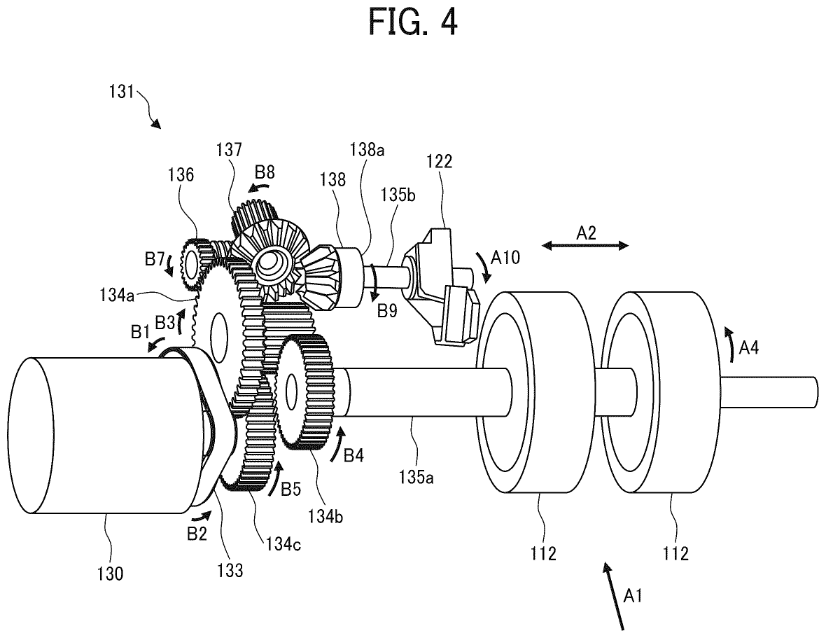

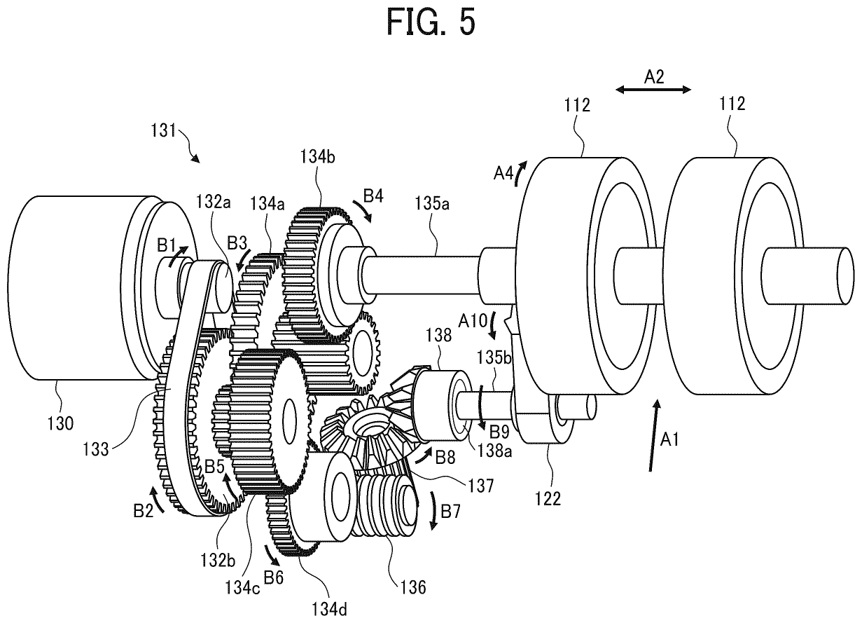

FIGS. 4 and 5 are schematic views of a driving mechanism of the feed roller 112 and the cam 122. FIG. 4 is a perspective view of the driving mechanism as viewed from the upstream side and the left side. FIG. 5 is a perspective view of the driving mechanism as viewed from the upstream side and the right side.

As illustrated in FIGS. 4 and 5, the medium conveying apparatus 100 includes a first motor 130 and a drive transmission assembly 131.

The first motor 130 is an example of a driving source, and generates a driving force for rotating (swinging) the feed roller 112 and the cam 122 according to a control signal from a processing circuit described later. The first motor 130 is, for example, a direct current (DC) motor. The first motor 130 is not limited to a DC motor but may be another motor such as a stepper motor. The first motor 130 generates a driving force for rotating the feed roller 112 in the medium feeding direction A4 and rotating (swinging) the cam 122 downward. One of the feed roller 112 and the cam 122 may be rotated by the driving force generated by a motor different from the first motor 130.

The drive transmission assembly 131 includes first and second pulleys 132a and 132b, a belt 133, first to fourth gears 134a to 134d, first and second shafts 135a and 135b, a worm 136, a worm wheel 137, and a bevel gear 138.

The first pulley 132a is mounted on the rotation shaft of the first motor 130. The belt 133 is stretched around the first pulley 132a and the second pulley 132b. The second pulley 132b includes a gear portion engaged with the first gear 134a. The first gear 134a is engaged with the second gear 134b. The second gear 134b is mounted on the first shaft 135a. Further, the feed roller 112 is mounted on the first shaft 135a. The first shaft 135a functions as the rotation shaft of the feed roller 112. The second gear 134b is further engaged with the third gear 134c. The third gear 134c is engaged with the fourth gear 134d.

The worm 136 and the worm wheel 137 are an example of a worm gear having a so-called self-lock function. The worm 136 is a cylindrical worm, and a gear is formed on the side surface of the worm 136. One end of the worm 136 includes a gear portion engaged with the fourth gear 134d, and a screw-shaped gear portion is formed on the rest of the worm 136. The worm wheel 137 includes helical teeth that engage with the screw-shaped gear formed on the side surface of the worm 136. Accordingly, the worm wheel 137 rotates following the rotation of the worm 136. The lead angle of the groove of the worm 136 is set to prevent the transmission of rotation from the worm wheel 137 to the worm 136. Thus, the worm 136 is not rotated by the rotation of the worm wheel 137, and generates a load that restricts the transmission to the fourth gear 134d of the force transmitted from the worm wheel 137. As a member that meshes with the worm 136, a helical gear may be used instead of the worm wheel 137.

One end of the worm wheel 137 includes a bevel gear portion engaged with the bevel gear 138. The bevel gear 138 is mounted on the second shaft 135b, and the cam 122 is further mounted on the second shaft 135b. The second shaft 135b functions as the rotation shaft of the cam 122. The bevel gear 138 includes a one-way clutch 138a. When the bevel gear 138 is rotated in the direction in which the set guide 121 is moved from the non-restrictive position to the restrictive position by the driving force from the first motor 130, the one-way clutch 138a transmits the rotational force of the bevel gear 138 to the second shaft 135b. In contrast, when the bevel gear 138 is rotated in the direction in which the set guide 121 is moved from the restrictive position to the non-restrictive position by the driving force from the first motor 130, the one-way clutch 138a idles the bevel gear 138 with respect to the second shaft 135b.

In the following description, operations of the cam 122 and the feed roller 112 will be described.

When the first motor 130 generates a driving force to rotate in the direction indicated by arrow B1, the first and second pulleys 132a and 132b rotate in the directions indicated by arrows B1 and B2, respectively. Accordingly, the first to fourth gears 134a to 134d rotate in the directions indicated by arrows B3 to B6, respectively, and the worm 136 and the worm wheel 137 rotate in the directions indicated by arrows B7 and B8, respectively. With the rotation, the bevel gear 138 rotates in the direction indicated by arrow B9, but the one-way clutch 138a does not transmit the rotational force of the bevel gear 138 to the second shaft 135b. However, the second shaft 135b becomes rotatable in the direction indicated by arrow B9. By contrast, the downward force is applied to the cam 122 by the elastic member 122a. Thus, the cam 122 rotates in the direction indicated by arrow B9 (downward direction A10) together with the second shaft 135b serving as the rotation shaft by the force from the elastic member 122a. Accordingly, the set guide 121 moves from the restrictive position to the non-restrictive position.

When the second gear 134b rotates in the direction indicated by arrow B4, the feed roller 112 rotates in the medium feeding direction A4 together with the first shaft 135a serving as the rotation shaft, by the driving force from the first motor 130. As described above, the drive transmission assembly 131 transmits the driving force for rotating the feed roller 112 from the first motor 130 to the feed roller 112.

In contrast, when the first motor 130 generates a driving force to rotate in the direction opposite to arrow B1, the first and second pulleys 132a and 132b, the first to fourth gears 134a to 134d, the worm 136, the worm wheel 137, and the bevel gear 138 rotate in the directions opposite to arrows B1 to B9, respectively. Accordingly, the cam 122 rotates in the upward direction, and the set guide 121 moves from the non-restrictive position to the restrictive position. As described above, the drive transmission assembly 131 transmits the driving force for moving the set guide 121 from the first motor 130 to the cam 122.

With the cam 122 moves upward and the set guide 121 is at the restrictive position, the elastic member 122a applies the downward force to the cam 122. Accordingly, a rotational force in the direction indicated by arrow B9 is applied to the second shaft 135b, and the rotational force of the second shaft 135b is transmitted to the worm wheel 137 via the one-way clutch 138a and the bevel gear 138. However, as described above, the worm 136 is not rotated by the rotation of the worm wheel 137, and generates a load that restricts the transmission to the fourth gear 134d of the force transmitted from the worm wheel 137. In other words, the drive transmission assembly 131 applies, to the cam 122, a load that restricts the transmission of the force from the set guide 121 to the first motor 130. In particular, the drive transmission assembly 131 applies, to the cam 122, a load that restricts the transmission of a force for moving the set guide 121 from the restrictive position to the non-restrictive position.

Accordingly, even when the supply of power to the first motor 130 is stopped with the set guide 121 positioned at the restrictive position, the set guide 121 is kept at the restrictive position. Thus, the medium conveying apparatus 100 can stop the supply of power to the first motor 130 before the medium is fed and can reduce power consumption. In particular, while the DC motor is low in cost and easily adjustable in speed, the detent torque of the DC motor, that is, the maximum torque when the DC motor is not energized, is low. Thus, when the first motor 130 is a DC motor, it is desirable to extremely increase the reduction ratio of each gear included in the driving mechanism to stop the set guide 121 at the restrictive position using the detent torque of the first motor 130. To extremely increase the reduction ratio of each gear, it is desirable to increase the mounting area of each gear, and as a result, the size of the apparatus increases. With the medium conveying apparatus 100, the load that restricts the transmission of the force for moving the set guide 121 from the restrictive position to the non-restrictive position is applied to the cam 122. Thus, the medium conveying apparatus 100 can reduce power consumption while reducing an increase in the size of the apparatus.

With the use of the worm gear, the medium conveying apparatus 100 can apply to the cam 122 the load that restricts the transmission of the force for moving the set guide 121 from the restrictive position to the non-restrictive position with a simple and inexpensive configuration. Thus, the medium conveying apparatus 100 can reduce power consumption while reducing an increase in the cost of the apparatus and the size of the apparatus.

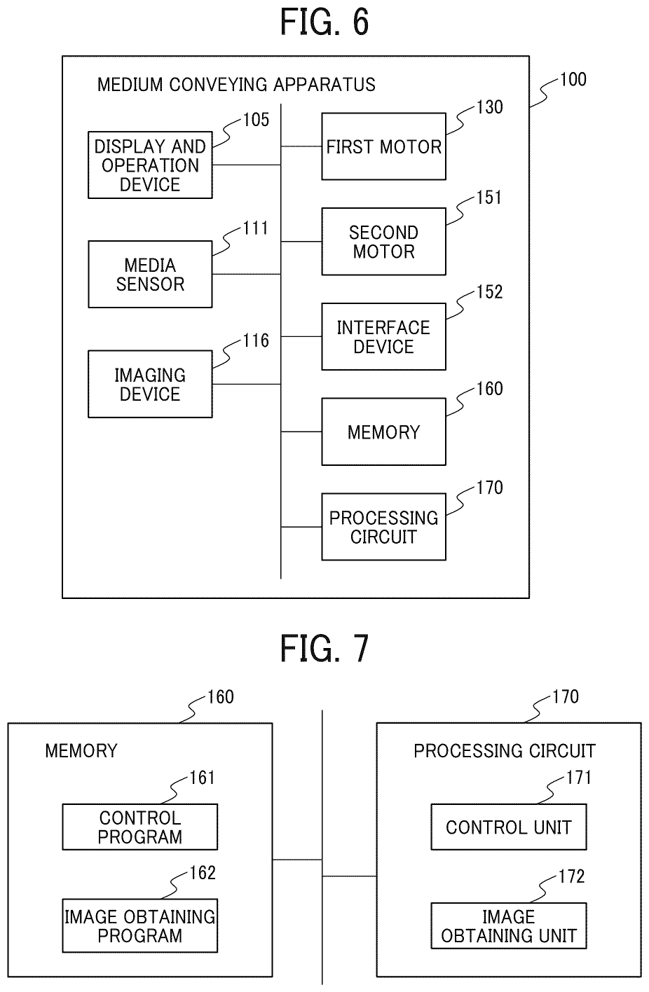

FIG. 6 is a schematic block diagram illustrating a schematic configuration of the medium conveying apparatus 100.

The medium conveying apparatus 100 further includes a second motor 151, an interface device 152, a memory 160, and a processing circuit 170 in addition to the above-described components.

The second motor 151 generates a driving force for rotating the separation roller 113, the first conveyance roller 114, the second conveyance roller 115, the first ejection roller 117, and the second ejection roller 118 according to a control signal from the processing circuit 170. The second motor 151 is, for example, a DC motor. The second motor 151 is not limited to a DC motor but may be another motor such as a stepper motor. The separation roller 113, the first conveyance roller 114, the second conveyance roller 115, the first ejection roller 117, and/or the second ejection roller 118 may be driven by the driving force from the first motor 130. The feed roller 112 and/or the cam 122 may be driven by the driving force from the second motor 151. The second conveyance roller 115 and the second ejection roller 118 may be driven rollers to be rotated by the first conveyance roller 114 and the first ejection roller 117, respectively. Further, the first conveyance roller 114, the second conveyance roller 115, the first ejection roller 117, and/or the second ejection roller 118 may be rotated by the driving force generated by a motor different from the first motor 130 and the second motor 151.

The interface device 152 includes an interface circuit compatible with a serial bus, such as a universal serial bus (USB), and is electrically connected to an information processing apparatus (e.g., a personal computer or a mobile information processing terminal) to transmit and receive input images and various kinds of information to and from the information processing apparatus. The interface device 152 may be substituted by a communication device that includes an antenna to transmit and receive wireless signals and a wireless communication interface device to transmit and receive signals through a wireless communication line according to a given communication protocol. The given communication protocol is, for example, a wireless local area network (LAN) communication protocol. The communication device may include a wired communication interface device to transmit and receive signals through a wired communication line according to a communication protocol, such as a wired LAN communication protocol.

The memory 160 includes memories, such as a random-access memory (RAM) and a read-only memory (ROM), a fixed disk device such as a hard disk, or a portable memory such as a flexible disk or an optical disk. The memory 160 stores, for example, computer programs, databases, and tables used for various processes performed by the medium conveying apparatus 100. The computer programs may be installed in the memory 160 from a computer-readable portable recording medium using, for example, a setup program. Examples of the portable recording medium include a compact disc read-only memory (CD-ROM) and a digital versatile disc read-only memory (DVD-ROM). The computer programs may be distributed from, for example, a server and installed in the memory 160.

The processing circuit 170 operates according to a program prestored in the memory 160. The processing circuit is, for example, a central processing unit (CPU). Alternatively, a digital signal processor (DSP), a large-scale integration (LSI), an application-specific integrated circuit (ASIC), a field-programmable gate array (FPGA), etc., may be used as the processing circuit 170.

The processing circuit 170 is connected to the display and operation device 105, the media sensor 111, the imaging device 116, the first motor 130, the second motor 151, the interface device 152, the memory 160, etc., and controls these devices. The processing circuit 170 controls the driving of the first motor 130 and the second motor 151, the imaging by the imaging device 116, etc., according to the media signals received from the media sensor 111. The processing circuit 170 obtains an input image from the imaging device 116 and transmits the input image to the information processing apparatus via the interface device 152.

FIG. 7 is a block diagram illustrating schematic configurations of the memory 160 and the processing circuit 170.

As illustrated in FIG. 7, the memory 160 stores a control program 161 and an image obtaining program 162. These programs are functional modules implemented by software that operates on the processor. The processing circuit 170 reads the programs from the memory 160 and operates according to the read programs. Accordingly, the processing circuit 170 functions as a control unit 171 and an image obtaining unit 172.

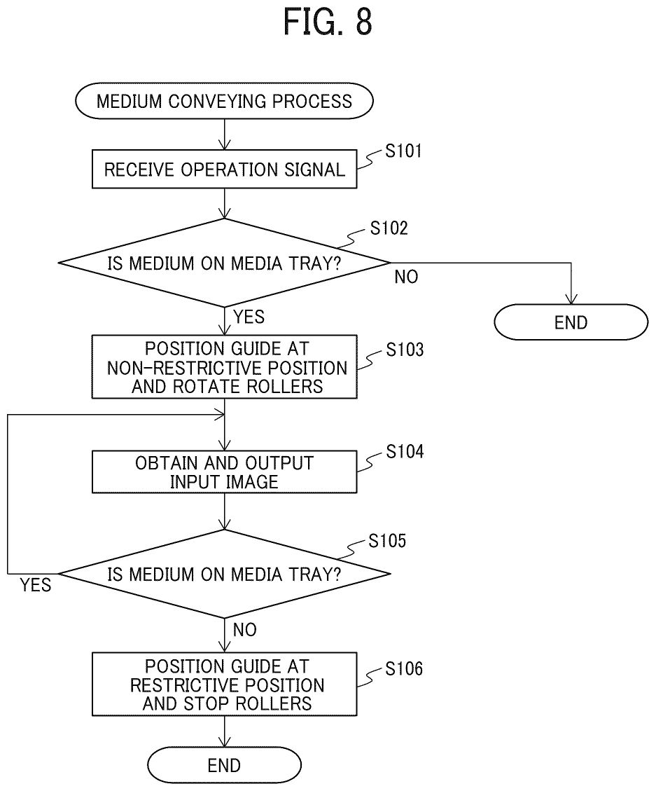

FIG. 8 is a flowchart of example operations of a medium conveying process performed by the medium conveying apparatus 100.

The example operations of the medium conveying process performed by the medium conveying apparatus 100 will be described below with reference to the flowchart of FIG. 8. The process described below is executed, for example, by the processing circuit 170 in cooperation with the components of the medium conveying apparatus 100 based on the program prestored in the memory 160.

When the medium conveying apparatus 100 is activated, the control unit 171 controls the first motor 130 to position the set guide 121 at the restrictive position. Accordingly, the set guide 121 is positioned at the restrictive position before the medium conveying process is performed.

In step S101, the control unit 171 stands by until an operation signal instructing the reading of a medium is received from the display and operation device 105 or the information processing apparatus via the interface device 152. The operation signal is output when a user inputs an instruction to read the medium using the display and operation device 105 or the information processing apparatus.

In step S102, the control unit 171 obtains a media signal from the media sensor 111 and determines whether a medium is placed on the media tray 103 based on the obtained media signal. The control unit 171 ends the series of steps when no medium is placed on the media tray 103.

When a medium is on the media tray 103, in step S103, the control unit 171 controls the first motor 130 and the second motor 151 to position the set guide 121 at the non-restrictive position and rotate the rollers to convey the medium. The control unit 171 controls the first motor 130 to rotate in the direction indicated by arrow B1 in FIGS. 4 and 5 to move the set guide 121 from the restrictive position to the non-restrictive position and rotate the feed roller 112 in the medium feeding direction A4. The control unit 171 rotates the second motor 151 to rotate the separation roller 113, the first conveyance roller 114, the second conveyance roller 115, the first ejection roller 117, and/or the second ejection roller 118 in the directions indicated by arrows A5 to A9 in FIG. 2, respectively.

In step S104, the image obtaining unit 172 controls the imaging device 116 to image the medium, obtains an input image from the imaging device 116, and transmits the obtained input image to the information processing apparatus via the interface device 152 to output the input image.

In step S105, the control unit 171 determines whether a medium remains on the media tray 103 based on the media signal received from the media sensor 111. When a medium remains on the media tray 103, the control unit 171 returns the process to step S104 and repeats the processes of steps S104 and S105.

In contrast, when no medium remains on the media tray 103, in step S106, the control unit 171 controls the first motor 130 and the second motor 151 to position the set guide 121 at the restrictive position and stop the rollers, and ends the series of steps. The control unit 171 controls the first motor 130 to rotate in the direction opposite to arrow B1 in FIGS. 4 and 5 for a certain period of time to move the set guide 121 from the non-restrictive position to the restrictive position. Then, the control unit 171 stops the first motor 130 to stop the feed roller 112. As described above, even when the supply of power to the first motor 130 is stopped with the set guide 121 positioned at the restrictive position, the set guide 121 stops at the restrictive position. The control unit 171 stops the second motor 151 to stop the separation roller 113, the first conveyance roller 114, the second conveyance roller 115, the first ejection roller 117, and/or the second ejection roller 118.

As described above in detail, the medium conveying apparatus 100 moves the cam 122 for moving the set guide 121 that restricts contact between the medium and the feed roller 112, by the driving force from the first motor 130. The medium conveying apparatus 100 applies, to the cam 122, the load that restricts the transmission of the force from the cam 122 to the first motor 130. Accordingly, even when the supply of power to the first motor 130 is stopped, the medium conveying apparatus 100 can continue to stop the set guide 121 at the position at which contact between the medium and the feed roller 112 is restricted. Thus, the medium conveying apparatus 100 can appropriately control the set guide 121 that restricts contact between the medium and the feed roller 112 while reducing an increase in power consumption.

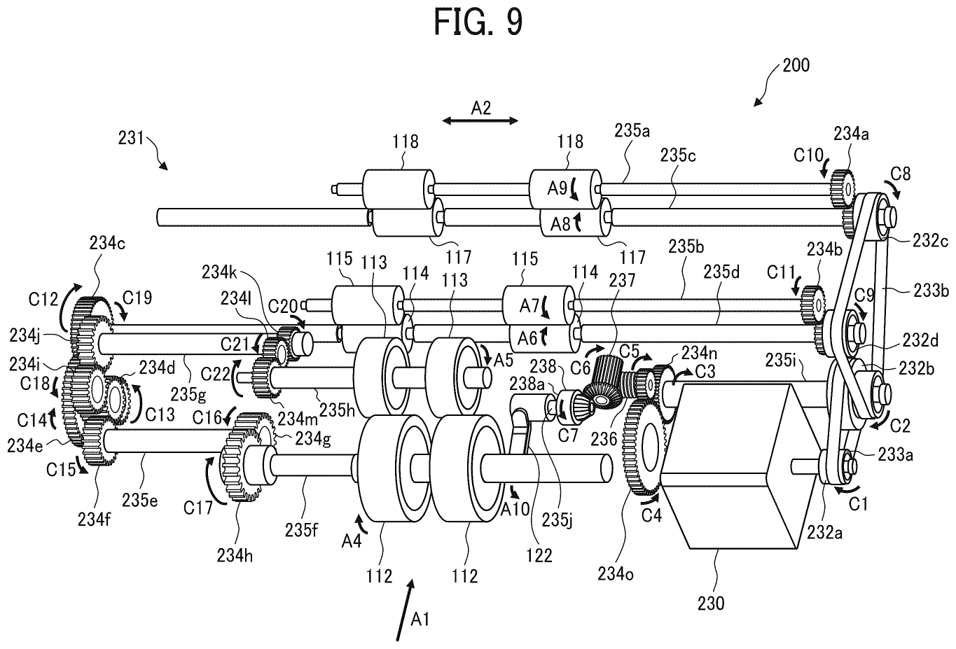

FIG. 9 is a schematic perspective view of a driving mechanism in a medium conveying apparatus 200 according to another embodiment. FIG. 9 is a perspective view of the driving mechanism as viewed from the upstream side and the upper side.

The medium conveying apparatus 200 has a structure and a function similar to those of the medium conveying apparatus 100. However, the medium conveying apparatus 200 includes a first motor 230 and a drive transmission assembly 231 instead of the first motor 130 and the drive transmission assembly 131.

The first motor 230 is an example of a driving source and has a configuration and a function similar to those of the first motor 130.

The drive transmission assembly 231 includes first to fourth pulleys 232a to 232d, first and second belts 233a and 233b, first to fifteenth gears 234a to 234o, first to tenth shafts 235a to 235j, a worm 236, a worm wheel 237, and a bevel gear 238.

The first pulley 232a is mounted on the rotation shaft of the first motor 230. The first belt 233a is stretched around the first pulley 232a and the second pulley 232b. The second belt 233b is stretched around the smaller pulley portion of the second pulley 232b, the third pulley 232c, and the fourth pulley 232d.

The third pulley 232c includes a gear portion engaged with the first gear 234a. The first gear 234a is mounted on the first shaft 235a, and the second ejection roller 118 is further mounted on the first shaft 235a. The first shaft 235a functions as the rotation shaft of the second ejection roller 118. The fourth pulley 232d includes a gear portion engaged with the second gear 234b. The second gear 234b is mounted on the second shaft 235b, and the second conveyance roller 115 is further mounted on the second shaft 235b. The second shaft 235b functions as the rotation shaft of the second conveyance roller 115. The third pulley 232c is mounted on the third shaft 235c, and the first ejection roller 117 is further mounted on the third shaft 235c. The third shaft 235c functions as the rotation shaft of the first ejection roller 117. The fourth pulley 232d is mounted on the fourth shaft 235d, and the first conveyance roller 114 is further mounted on the fourth shaft 235d. The fourth shaft 235d functions as the rotation shaft of the first conveyance roller 114.

The third gear 234c is further mounted on the fourth shaft 235d. The third gear 234c is engaged with the fourth gear 234d. The fourth gear 234d is engaged with the fifth gear 234c. The fifth gear 234c is engaged with the sixth gear 234f. The sixth gear 234f is mounted on the fifth shaft 235c, and the seventh gear 234g is further mounted on the fifth shaft 235c. The seventh gear 234g is further engaged with the eighth gear 234h. The eighth gear 234h is mounted on the sixth shaft 235f, and the feed roller 112 is further mounted on the sixth shaft 235f. The sixth shaft 235f functions as the rotation shaft of the feed roller 112.

The fifth gear 234e is further engaged with the ninth gear 234i. The ninth gear 234i is engaged with the tenth gear 234j. The tenth gear 234j is mounted on the seventh shaft 235g, and the eleventh gear 234k is further mounted on the seventh shaft 235g. The eleventh gear 234k is engaged with the twelfth gear 2341. The twelfth gear 2341 is engaged with the thirteenth gear 234m. The thirteenth gear 234m is mounted on the eighth shaft 235h, and the separation roller 113 is further mounted on the eighth shaft 235h. The eighth shaft 235h functions as the rotation shaft of the separation roller 113.

The second pulley 232b is mounted on the ninth shaft 235i, and the fourteenth gear 234n is further mounted on the ninth shaft 235i. The fourteenth gear 234n is engaged with the fifteenth gear 234o.

The worm 236 and the worm wheel 237 have configurations and functions similar to those of the worm 136 and the worm wheel 137, respectively. The worm 236 includes a gear portion formed on one end portion of the worm 236 and engaged with the fifteenth gear 234o, and a screw-shaped gear portion formed on the other portion of the worm 236. The worm wheel 237 includes helical teeth that engage with the screw-shaped gear portion formed on the side surface of the worm 236.

The worm wheel 237 includes a bevel gear portion formed on one end of the worm wheel 237. The bevel gear portion of the worm wheel 237 is engaged with the bevel gear 238. The bevel gear 238 is mounted on the tenth shaft 235j, and the cam 122 is further mounted on the tenth shaft 235j. The tenth shaft 235j functions as the rotation shaft of the cam 122. The bevel gear 238 includes a one-way clutch 238a. When the bevel gear 238 is rotated in the direction in which the set guide 121 is moved from the non-restrictive position to the restrictive position by the driving force from the first motor 230, the one-way clutch 238a transmits the rotational force of the bevel gear 238 to the tenth shaft 235j. In contrast, when the bevel gear 238 is rotated in the direction in which the set guide 121 is moved from the restrictive position to the non-restrictive position by the driving force from the first motor 230, the one-way clutch 238a idles the bevel gear 238 with respect to the tenth shaft 235j.

In the following description, operations of the cam 122 and the feed roller 112 will be described.

When the first motor 230 generates a driving force to rotate in the direction indicated by arrow C1, the first and second pulleys 232a and 232b rotate in the directions indicated by arrows C1 and C2, respectively. Accordingly, the fourteenth and fifteenth gears 234n and 234o rotate in the directions indicated by arrows C3 and C4, respectively, and the worm 236 and the worm wheel 237 rotate in the directions indicated by arrows C5 and C6, respectively. With the rotation, the bevel gear 238 rotates in the direction indicated by arrow C7, but the one-way clutch 238a does not transmit the rotational force of the bevel gear 238 to the tenth shaft 235j. However, the tenth shaft 235j becomes a rotatable state in the direction indicated by arrow C7. The downward force is applied to the cam 122 by the elastic member 122a. Thus, the cam 122 rotates in the direction indicated by arrow C7 (downward direction A10) together with the tenth shaft 235j serving as the rotation shaft by the force from the elastic member 122a. Accordingly, the set guide 121 moves from the restrictive position to the non-restrictive position.

When the second pulley 232b rotates in the direction indicated by arrow C2, the third pulley 232c and the fourth pulley 232d rotate in the directions indicated by arrows C8 and C9, respectively, and the first gear 234a and the second gear 234b rotate in the directions indicated by arrows C10 and C11, respectively. Accordingly, the second ejection roller 118 and the second conveyance roller 115 rotate in the medium conveying directions A9 and A7, respectively, together with the first shaft 235a and the second shaft 235b serving as the rotation shafts, by the driving force from the first motor 230. The first ejection roller 117 and the first conveyance roller 114 rotate in the medium conveying directions A8 and A6, respectively, together with the third shaft 235c and the fourth shaft 235d serving as the rotation shafts, by the driving force from the first motor 230.

The third to eighth gears 234c to 234h rotate in the directions indicated by arrows C12 to C17, respectively, and the feed roller 112 rotates in the medium feeding direction A4 together with the sixth shaft 235f serving as the rotation shaft, by the driving force from the first motor 230. The ninth to thirteenth gears 234i to 234m rotate in the directions indicated by arrows C18 to C22, respectively, and the separation roller 113 rotates in the direction A5 opposite to the medium feeding direction A4 together with the eighth shaft 235h serving as the rotation shaft, by the driving force from the first motor 230. As described above, the drive transmission assembly 231 transmits the driving force for driving the rollers, from the first motor 230 to the feed roller 112, the separation roller 113, the first conveyance roller 114, the second conveyance roller 115, the first ejection roller 117, and/or the second ejection roller 118.

In contrast, when the first motor 230 generates a driving force to rotate in the direction opposite to arrow C1, the first and second pulleys 232a and 232b, the fourteenth and fifteenth gears 234n and 234o, the worm 236, the worm wheel 237, and the bevel gear 238 rotate in the directions opposite to arrows C1 to C7, respectively. Accordingly, the cam 122 rotates in the upward direction, and the set guide 121 moves from the non-restrictive position to the restrictive position. As described above, the drive transmission assembly 231 transmits the driving force for moving the set guide 121, from the first motor 230 to the cam 122. With the cam 122 moves upward and the set guide 121 is at the restrictive position, the elastic member 122a applies the downward force to the cam 122. Accordingly, a force to rotate in the direction indicated by arrow C7 is applied to the tenth shaft 235j, and the rotational force of the tenth shaft 235j is transmitted to the worm wheel 237 via the one-way clutch 238a and the bevel gear 238. However, the worm 236 does not rotate following the rotation from the worm wheel 237, and generates a load to restrict the transmission to the fifteenth gear 234o of the force transmitted from the worm wheel 237. In other words, the drive transmission assembly 231 applies, to the cam 122, a load that restricts the transmission of the force from the set guide 121 to the first motor 230. In particular, the drive transmission assembly 231 applies, to the cam 122, a load that restricts the transmission of the force for moving the set guide 121 from the restrictive position to the non-restrictive position. Accordingly, even when the supply of power to the first motor 230 is stopped with the set guide 121 positioned at the restrictive position, the set guide 121 stops at the restrictive position.

As described above in detail, even when the first motor 230 drives the separation roller 113, the first conveyance roller 114, the second conveyance roller 115, the first ejection roller 117, and/or the second ejection roller 118, the medium conveying apparatus 200 can appropriately control the set guide 121 that restricts contact between the medium and the feed roller 112 while reducing an increase in power consumption.

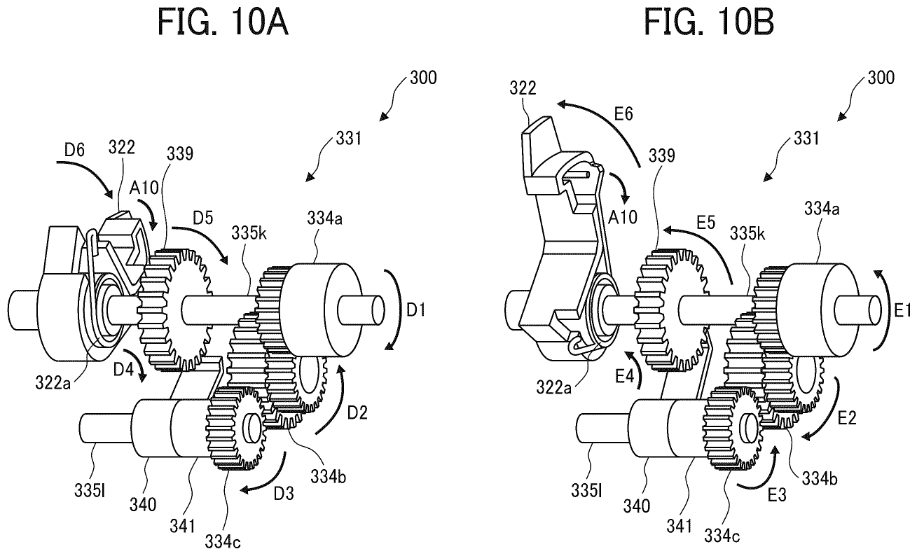

FIGS. 10A and 10B are schematic views illustrating a driving mechanism in a medium conveying apparatus 300 according to still another embodiment.

The medium conveying apparatus 300 has a structure and a function similar to those of the medium conveying apparatus 100 or 200. However, the medium conveying apparatus 300 includes a cam 322 and a drive transmission assembly 331 instead of the cam 122 and the drive transmission assembly 131 or 231. The cam 322 and the drive transmission assembly 331 have configurations and functions similar to those of the cam 122 and the drive transmission assembly 131 or 231. However, the cam 322 is provided with an elastic member 322a. The elastic member 322a has a configuration and a function similar to those of the elastic member 122a.

The drive transmission assembly 331 includes a one-way clutch gear 334a, a reduction gear 334b, an idler gear 334c, eleventh and twelfth shafts 335k and 3351, a ratchet gear 339, a ratchet arm 340, and a ratchet sliding spring 341 instead of the worm, the worm wheel, and the bevel gear.

The one-way clutch gear 334a is engaged with the fourth gear 134d or the fifteenth gear 234o. The one-way clutch gear 334a is mounted on the eleventh shaft 335k, and the ratchet gear 339 and the cam 322 are further mounted on the eleventh shaft 335k. The eleventh shaft 335k functions as the rotation shaft of the cam 322. When the one-way clutch gear 334a is rotated by the first motor in the direction in which the set guide 121 is moved from the non-restrictive position to the restrictive position, the one-way clutch gear 334a transmits the rotational force to the eleventh shaft 335k. In contrast, when the one-way clutch gear 334a is rotated by the first motor in the direction in which the set guide 121 is moved from the restrictive position to the non-restrictive position, the one-way clutch gear 334a idles with respect to the eleventh shaft 335k.

The one-way clutch gear 334a is engaged with the reduction gear 334b. The reduction gear 334b is engaged with the idler gear 334c. The idler gear 334c is rotatably mounted on the twelfth shaft 3351, and the ratchet arm 340 is further rotatably mounted on the twelfth shaft 3351. The ratchet arm 340 prevents the cam 322 from rotating in the direction in which the set guide 121 is moved from the restrictive position to the non-restrictive position when the ratchet arm 340 is engaged with the ratchet gear 339. However, the ratchet arm 340 does not prevent the cam 322 from rotating in the direction in which the set guide 121 is moved from the non-restrictive position to the restrictive position when the ratchet arm 340 is engaged with the ratchet gear 339. The ratchet sliding spring 341 is located between the idler gear 334c and the ratchet arm 340 to contact the idler gear 334c and the ratchet arm 340, and transmits the rotational force from the idler gear 334c to the ratchet arm 340. Instead of the ratchet sliding spring 341, a torque limiter may be used.

In the following description, operations of the cam 322 and the feed roller 112 will be described.

When the first motor generates a driving force to rotate the feed roller 112 in the medium feeding direction A4, as illustrated in FIG. 10A, the one-way clutch gear 334a rotates in the direction indicated by arrow D1. With the rotation, the reduction gear 334b and the idler gear 334c rotate in the directions indicated by arrows D2 and D3, respectively. When the idler gear 334c rotates in the direction indicated by arrow D3, the ratchet arm 340 rotates in the direction indicated by arrow D4 via the ratchet sliding spring 341, and the ratchet arm 340 separates from the ratchet gear 339. Accordingly, the ratchet gear 339 is not locked, and the cam 322 rotates in the direction indicated by arrow D6 (downward direction A10) together with the eleventh shaft 335k rotating in the direction indicated by arrow D5. The eleventh shaft 335k serves as the rotation shaft. Accordingly, the set guide 121 moves from the restrictive position to the non-restrictive position.

In contrast, when the first motor generates a driving force to rotate the feed roller 112 in the direction opposite to the medium feeding direction A4, as illustrated in FIG. 10B, the one-way clutch gear 334a rotates in the direction indicated by arrow El. With the rotation, the reduction gear 334b and the idler gear 334c rotate in the directions indicated by arrows E2 and E3, respectively. When the idler gear 334c rotates in the direction indicated by arrow E3, the ratchet arm 340 rotates in the direction indicated by arrow E4 via the ratchet sliding spring 341, and the ratchet arm 340 is engaged with the ratchet gear 339. However, as described above, the ratchet gear 339 and the ratchet arm 340 do not prevent the cam 322 from rotating in the direction in which the set guide 121 is moved from the non-restrictive position to the restrictive position. Thus, the cam 322 rotates in the direction indicated by arrow E6 (upward direction) together with the eleventh shaft 335k serving as the rotation shaft. Accordingly, the set guide 121 moves from the non-restrictive position to the restrictive position.

With the cam 322 moved in the upward direction and the set guide 121 positioned at the restrictive position, a downward force is applied to the cam 322 by the elastic member 322a. Accordingly, a force to rotate in the direction opposite to arrow E5 is applied to the eleventh shaft 335k, and the rotational force of the eleventh shaft 335k is transmitted to the ratchet gear 339. However, as described above, the ratchet gear 339 and the ratchet arm 340 prevent the cam 322 from rotating in the direction in which the set guide 121 is moved from the restrictive position to the non-restrictive position. Accordingly, the ratchet gear 339 and the ratchet arm 340 generate a load to restrict the transmission to the one-way clutch gear 334a of the force transmitted from the eleventh shaft 335k. In other words, the drive transmission assembly 331 applies, to the cam 322, a load that restricts the transmission of the force from the set guide 121 to the first motor 130. In particular, the drive transmission assembly 331 applies, to the cam 322, a load that restricts the transmission of the force for moving the set guide 121 from the restrictive position to the non-restrictive position. Accordingly, even when the supply of power to the first motor 130 is stopped with the set guide 121 positioned at the restrictive position, the set guide 121 is kept at the restrictive position.

In particular, with the use of the ratchet gear 339, the medium conveying apparatus 300 can apply the load that restricts the transmission of the force for moving the set guide 121 from the restrictive position to the non-restrictive position, to the cam 322 with a simple and inexpensive configuration. Thus, the medium conveying apparatus 300 can reduce power consumption while reducing an increase in the cost of the apparatus and the size of the apparatus.

As described above in detail, even when using the ratchet gear 339, the medium conveying apparatus 300 can appropriately control the set guide 121 that restricts contact between the medium and the feed roller 112 while reducing an increase in power consumption.

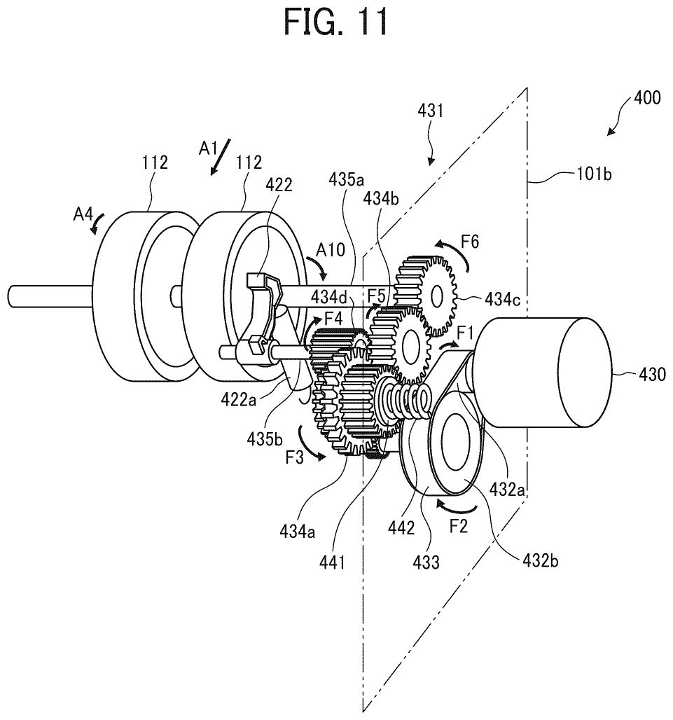

FIG. 11 is a schematic perspective view of a driving mechanism in a medium conveying apparatus 400 according to still another embodiment.

The medium conveying apparatus 400 has a structure and a function similar to those of the medium conveying apparatus 100 or 200. However, the medium conveying apparatus 400 includes a cam 422, a first motor 430, and a drive transmission assembly 431 instead of the cam 122, the first motor 130 or 230, and the drive transmission assembly 131 or 231. The cam 422 has a configuration and a function similar to those of the cam 122. However, the cam 422 is provided with an elastic member 422a. The elastic member 422a has a configuration and a function similar to those of the elastic member 122a.

The first motor 430 is an example of a driving source and has a configuration and a function similar to those of the first motor 130 or 230.

The drive transmission assembly 431 includes first and second pulleys 432a and 432b, a belt 433, first to third gears 434a to 434c, a one-way clutch gear 434d, first and second shafts 435a and 435b, a sliding member 441, and a pressing part 442.

The first pulley 432a is mounted on the rotation shaft of the first motor 430. The belt 433 is stretched around the first pulley 432a and the second pulley 432b. The second pulley 432b includes a gear portion engaged with the first gear 434a. The first gear 434a is engaged with the second gear 434b. The second gear 434b is engaged with the third gear 434c. The third gear 434c is mounted on the first shaft 435a, and the feed roller 112 is further mounted on the first shaft 435a. The first shaft 435a functions as the rotation shaft of the feed roller 112. The first gear 434a is engaged with the one-way clutch gear 434d. The one-way clutch gear 434d is mounted on the second shaft 435b, and the cam 422 is further mounted on the second shaft 435b. The second shaft 435b functions as the rotation shaft of the cam 422. When the one-way clutch gear 434d is rotated by the driving force from the first motor 430 in the direction in which the set guide 121 is moved from the non-restrictive position to the restrictive position, the one-way clutch gear 434d transmits the rotational force to the second shaft 435b. In contrast, when the one-way clutch gear 434d is rotated by the driving force from the first motor 430 in the direction in which the set guide 121 is moved from the restrictive position to the non-restrictive position, the one-way clutch gear 434d idles with respect to the second shaft 435b.

The sliding member 441 is formed of, for example, rubber, resin, or metal, and contacts the first gear 434a. In particular, the sliding member 441 contacts the side surface, that is, a surface intersecting the rotation axis of the first gear 434a. The sliding member 441 applies a frictional force that restricts the rotation of the first gear 434a to the first gear 434a. Accordingly, the sliding member 441 can efficiently apply the frictional force to the first gear 434a and appropriately restrict the rotation of the first gear 434a.

The pressing part 442 is a spring, such as a compression coil spring. The pressing part 442 may be another elastic member, such as another spring (e.g., a flat spring) or a rubber member. One end of the pressing part 442 is attached to a frame 101b fixed to the lower housing 101, and the other end of the pressing part 442 is attached to a surface of the sliding member 441 on a side opposite to the first gear 434a. The pressing part 442 presses the sliding member 441 toward the side opposite to the frame 101b. Accordingly, the medium conveying apparatus 400 can appropriately restrict the rotation of the first gear 434a.

The sliding member 441 may be omitted, and the pressing part 442 may directly press the first gear 434a. Instead of the pressing part 442, a fixing member or the like to fix the sliding member 441 at a position at which the sliding member 441 is in contact with the first gear 434a may be used.

The force that is applied to the first gear 434a by the sliding member 441 and/or the pressing part 442 is set to be smaller than the force that is applied to the first gear 434a by the driving force from the first motor 430 and larger than the force that is applied to the first gear 434a by the elastic member 422a.

In the following description, operations of the cam 422 and the feed roller 112 will be described.

When the first motor 430 generates a driving force to rotate in the direction indicated by arrow F1, the first and second pulleys 432a and 432b rotate in the directions indicated by arrows F1 and F2, respectively. As described above, the force that is applied to the first gear 434a by the sliding member 441 and/or the pressing part 442 is set to be smaller than the force that is applied to the first gear 434a by the driving force from the first motor 430. Thus, the first gear 434a rotates in the direction indicated by arrow F3 by the driving force from the first motor 430. With the rotation, the one-way clutch gear 434d rotates in the direction indicated by arrow F4, but the rotational force of the one-way clutch gear 434d is not transmitted to the second shaft 435b. However, the second shaft 435b becomes a rotatable state in the direction indicated by arrow F4. A downward force is applied to the cam 422 by the elastic member 422a. Thus, the cam 422 rotates in the direction indicated by arrow F4 (downward direction A10) together with the second shaft 435b serving as the rotation shaft by the force from the elastic member 422a. Accordingly, the set guide 121 moves from the restrictive position to the non-restrictive position.

When the second and third gears 434b and 434c rotate in the directions indicated by arrows F5 to F6, the feed roller 112 rotates in the medium feeding direction A4 together with the first shaft 435a serving as the rotation shaft, by the driving force from the first motor 430. As described above, the drive transmission assembly 431 transmits the driving force for rotating the feed roller 112, from the first motor 430 to the feed roller 112.

In contrast, when the first motor 430 generates a driving force to rotate in the direction opposite to arrow F1, the first and second pulleys 432a and 432b, the first gear 434a, the one-way clutch gear 434d, and the second and third gears 434b and 434c rotate in the directions opposite to arrows FI to F6, respectively. Accordingly, the cam 422 rotates in the upward direction, and the set guide 121 moves from the non-restrictive position to the restrictive position. As described above, the drive transmission assembly 431 transmits the driving force for moving the set guide 121, from the first motor 430 to the cam 422.

With the cam 422 moved in the upward direction and the set guide 121 positioned at the restrictive position, the downward force is applied to the cam 422 by the elastic member 422a. Accordingly, a force to rotate in the direction indicated by arrow F4 is applied to the second shaft 435b, and the rotational force of the second shaft 435b is transmitted to the first gear 434a via the one-way clutch gear 434d. However, as described above, the force that is applied to the first gear 434a by the sliding member 441 and/or the pressing part 442 is larger than the force that is applied to the first gear 434a by the elastic member 422a. In other words, the drive transmission assembly 431 applies, to the cam 422, a load that restricts the transmission of the force from the set guide 121 to the first motor 430. In particular, the drive transmission assembly 431 applies, to the cam 422, a load that restricts the transmission of the force for moving the set guide 121 from the restrictive position to the non-restrictive position. Accordingly, even when the supply of power to the first motor 430 is stopped with the set guide 121 positioned at the restrictive position, the set guide 121 stops at the restrictive position.

With the use of the sliding member 441 and/or the pressing part 442, the medium conveying apparatus 400 can apply the load that restricts the transmission of the force for moving the set guide 121 from the restrictive position to the non-restrictive position, to the cam 422 with a simple and inexpensive configuration. Thus, the medium conveying apparatus 400 can reduce power consumption while reducing an increase in the cost of the apparatus and the size of the apparatus.

As described above in detail, even when using the sliding member 441 and/or the pressing part 442, the medium conveying apparatus 400 can appropriately control the set guide 121 that restricts contact between the medium and the feed roller 112 while reducing an increase in power consumption.

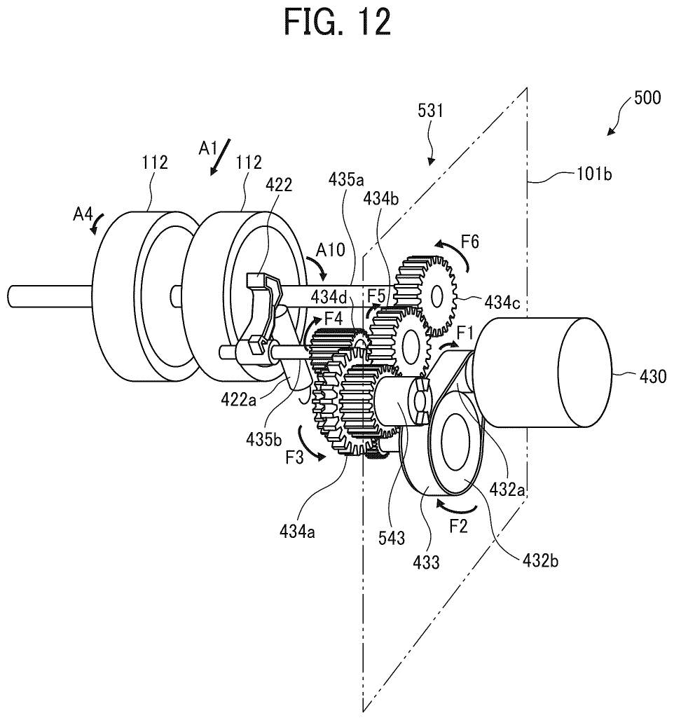

FIG. 12 is a schematic perspective view of a driving mechanism in a medium conveying apparatus 500 according to still another embodiment.

The medium conveying apparatus 500 has a structure and a function similar to those of the medium conveying apparatus 400. However, the medium conveying apparatus 500 includes a drive transmission assembly 531 instead of the drive transmission assembly 431. The drive transmission assembly 531 has a configuration and a function similar to those of the drive transmission assembly 431. However, the drive transmission assembly 531 includes a torque limiter 543 instead of the sliding member 441 and/or the pressing part 442.

The torque limiter 543 is attached to the first gear 434a and is fixed to the frame 101b fixed to the lower housing 101. The torque limiter 543 is set such that the first gear 434a rotates when the driving force of the first motor 430 is transmitted to the first gear 434a, and the first gear 434a stops when only the force of the elastic member 422a is transmitted to the first gear 434a.

In the following description, operations of the cam 422 and the feed roller 112 will be described.

When the first motor 430 generates a driving force to rotate in the direction indicated by arrow F1, the first and second pulleys 432a and 432b rotate in the directions indicated by arrows F1 and F2, respectively. As described above, the torque limiter 543 is set such that the first gear 434a rotates when the driving force of the first motor 430 is transmitted to the first gear 434a. Thus, the first gear 434a rotates in the direction indicated by arrow F3 by the driving force from the first motor 430. Accordingly, similarly to the case of the medium conveying apparatus 400, the set guide 121 moves from the restrictive position to the non-restrictive position, and the feed roller 112 rotates in the medium feeding direction A4.

In contrast, when the first motor 430 generates a driving force to rotate in the direction opposite to arrow F1, the set guide 121 moves from the non-restrictive position to the restrictive position.

With the cam 422 moved in the upward direction and the set guide 121 positioned at the restrictive position, the downward force is applied to the cam 422 by the elastic member 422a. Accordingly, a force to rotate in the direction indicated by arrow F4 is applied to the second shaft 435b, and the rotational force of the second shaft 435b is transmitted to the first gear 434a via the one-way clutch gear 434d. However, as described above, the torque limiter 543 is set such that the first gear 434a stops when only the force of the elastic member 422a is transmitted to the first gear 434a. In other words, the drive transmission assembly 531 applies, to the cam 422, a load that restricts the transmission of the force from the set guide 121 to the first motor 430. In particular, the drive transmission assembly 531 applies, to the cam 422, a load that restricts the transmission of the force for moving the set guide 121 from the restrictive position to the non-restrictive position. Accordingly, even when the supply of power to the first motor 430 is stopped with the set guide 121 positioned at the restrictive position, the set guide 121 stops at the restrictive position.

With the use of the torque limiter 543, the medium conveying apparatus 500 can apply the load that restricts the transmission of the force for moving the set guide 121 from the restrictive position to the non-restrictive position, to the cam 422 with a simple and inexpensive configuration. Thus, the medium conveying apparatus 500 can reduce power consumption while reducing an increase in the cost of the apparatus and the size of the apparatus.

As described above in detail, even when using the torque limiter 543, the medium conveying apparatus 500 can appropriately control the set guide 121 that restricts contact between the medium and the feed roller 112 while reducing an increase in power consumption.

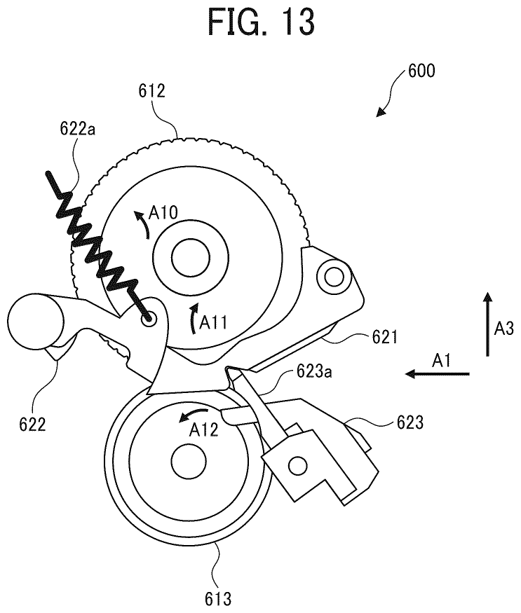

FIG. 13 is a schematic diagram illustrating a medium conveying apparatus 600 according to still another embodiment.

The medium conveying apparatus 600 has a structure and a function similar to those of any one of the medium conveying apparatuses 100 to 500. However, the medium conveying path of the medium conveying apparatus 600 is a so-called U-turn path, feeds and conveys media placed on the media tray 103 sequentially from the top, and ejects the media onto the ejection tray 104. The medium conveying apparatus 600 includes a feed roller 612, a separation roller 613, a set guide 621, a cam 622, an elastic member 622a, an arm 623, and a flap 623a instead of the feed roller, the separation roller, the set guide, the cam, the elastic member, the arm, and the flap included in any one of the medium conveying apparatuses 100 to 500. The feed roller 612, the separation roller 613, the set guide 621, the cam 622, the elastic member 622a, the arm 623, and the flap 623a have configurations and functions similar to those of the feed roller, the separation roller, the set guide, the cam, the elastic member, the arm, and the flap included in any one of the medium conveying apparatuses 100 to 500, respectively.

However, the feed roller 612 is located above the separation roller 613. The set guide 621, the cam 622, and the elastic member 622a are located above the medium conveying path, and the arm 623 is located below the medium conveying path. The elastic member 622a applies an upward force to the cam 622. That is, the feed roller 612, the separation roller 613, the set guide 621, the cam 622, the elastic member 622a, the arm 623, and the flap 623a are located upside down with respect to the feed roller, the separation roller, the set guide, the cam, the elastic member, the arm, and the flap included in any one of the medium conveying apparatuses 100 to 500, respectively.

As described above in detail, even when the set guide 621 is located above the medium conveying path, the medium conveying apparatus 600 can appropriately control the set guide 621 that restricts contact between the medium and the feed roller 612 while reducing an increase in power consumption.

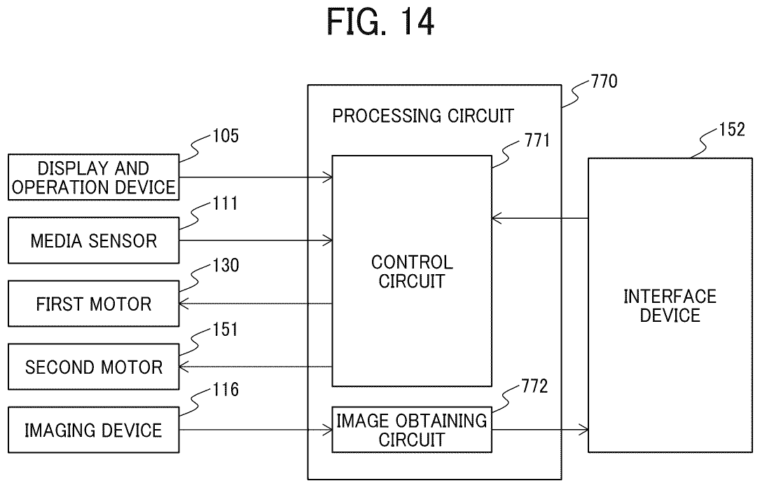

FIG. 14 is a block diagram of a schematic configuration of a processing circuit 770 of a medium conveying apparatus according to still another embodiment.

The processing circuit 770 substitutes for the processing circuit 170 and performs the medium conveying process, etc., instead of the processing circuit 170. The processing circuit 770 includes a control circuit 771 and an image obtaining circuit 772. These circuits may be implemented by independent integrated circuits, microprocessors, firmware, or a combination thereof.

The control circuit 771 is an example of a control unit and functions like the control unit 171. The control circuit 771 receives an operation signal from the display and operation device 105 or the interface device 152 and receives a media signal from the media sensor 111. The control circuit 771 controls the first motor 130 and the second motor 151 based on the received items of information.

The image obtaining circuit 772 is an example of an image obtaining unit and functions like the image obtaining unit 172. The image obtaining circuit 772 obtains an input image from the imaging device 116 and outputs the input image to the interface device 152.

As described above in detail, even when using the processing circuit 770, the medium conveying apparatus can appropriately control the set guide 621 that restricts contact between the medium and the feed roller 612 while reducing an increase in power consumption.

Embodiments of the present disclosure are not limited to the above-described embodiments. For example, the medium conveying apparatus may include an image forming device instead of or in addition to the imaging device 116. The image forming device employs, for example, an inkjet printing method or a laser printing method, is located at the position corresponding to the position of the imaging device 116, and forms an image (prints information) on a medium being conveyed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A medium conveying apparatus comprising:
a feed roller to feed a medium;
a guide to restrict contact between the medium and the feed roller;
a moving mechanism to move the guide;
a driving source; and
a drive transmission assembly to transmit a driving force for moving the guide from the driving source to the moving mechanism,
wherein the drive transmission assembly applies a load to the moving mechanism, and the load restricts transmission of force from the guide to the driving source.

2. The medium conveying apparatus according to claim 1, wherein
the guide is positioned at a first position to restrict the contact between the medium and the feed roller and at a second position to allow the medium to contact the feed roller,
the moving mechanism moves the guide between the first position and the second position, and
the drive transmission assembly applies, to the moving mechanism, a load that restricts transmission of a force for moving the guide from the first position to the second position.

3. The medium conveying apparatus according to claim 1,
wherein the drive transmission assembly includes a worm gear including a worm and a worm wheel.

4. The medium conveying apparatus according to claim 1,
wherein the drive transmission assembly includes a ratchet gear.

5. The medium conveying apparatus according to claim 1,
wherein the drive transmission assembly includes a pressing part.

6. The medium conveying apparatus according to claim 1,
wherein the drive transmission assembly includes a sliding member.

7. The medium conveying apparatus according to claim 1,
wherein the drive transmission assembly includes a torque limiter.

8. The medium conveying apparatus according to claim 2, further comprising:
a media tray;
a separation roller located facing the feed roller; and
a restricting portion engaged with the guide positioned at the first position,
wherein the restricting portion restricts contact between a leading end of the medium placed on the media tray and the separation roller before the medium is fed.

9. The medium conveying apparatus according to claim 2, further comprising an elastic member to apply a load in a direction in which the guide moves from the first position to the second position to the moving mechanism.

10. The medium conveying apparatus according to claim 1,
wherein the driving source includes a direct current motor.
